(19) United States
(12) Patent Application Publication
(10) Pub. No.: US 2004/0065989 A1
(43) Pub. Date: Apr. 8, 2004

(54) Motionless conduit vise

(76) Inventor: William F. Campbell, Rockford, IL (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/265,927

(22) Filed: Oct. 7, 2002

(51) Int. Cl. B25B 1/00

(52) U.S. Cl. 269/17

(57) ABSTRACT

A motionless conduit vise is disclosed to include a base in which one or more receiving channels are provided. Each of the channels are sized to be slightly less than the outer diameter of the conduit to be held therein and thereby frictionally hold the conduit against linear or rotational movement once secured. A plurality of mounting structures is also disclosed so as to facilitate provision of the vise on a variety of work surfaces, such as moveable carts, pails, and ladders.

### FIELD OF THE DISCLOSURE

The disclosure generally relates to tools and, more particularly, to hand tools, vises, and jigs.

### BACKGROUND OF THE DISCLOSURE

In many forms of construction, conduit must be sized and cut to certain dimensions. For example, when installing electrical wiring, local codes may require that the conductors are pulled through metallic tubing. Such tubing or conduit, referred to as EMT (Electrical Metallic Tubing), is commonly manufactured from aluminum, steel, or the like in a variety of diameters depending on the number of conductors or wires to be pulled through the conduit. For example, the conduit is often provided in diameters ranging from one half inch to one inch, although other sizes are certainly possible.

As the EMT is manufactured from metal, saws of various types need to be employed to cut the tubing to length prior to installation. This is often conducted using a manual hacksaw, or powered reciprocating or circular saw. While such saws themselves are effective, the installer is often confronted with difficulty in securing the conduit during the sawing operation. As the installer is often, if not always, on a work site, the availability of flat work space or the like is often low. As a result, the process typically involves the worker holding the conduit against one's body or a make-shift surface such as a pail, ladder, or floor, thereby reducing the ability of the worker to hold the conduit steady.

It is possible, and known, to hold the conduit in a traditional vise or the like, but this of course depends on the availability of such a vise. Moreover, due to the cylindrical shape of the conduit, and the traditionally flat opposed surfaces of conventional vises, the conduit tends to rotate during the cut. In order to overcome this, the vise jaws can be tightened to a degree sufficient to hold the conduit motionless, but it is difficult to reach such a point without detrimentally effecting or deforming the cylindrical shape of the conduit itself.

### SUMMARY OF THE DISCLOSURE

In accordance with one aspect of the disclosure, a conduit vise is disclosed which may include a base and a channel formed in the base adapted to frictionally receive conduit therein.

In accordance with another aspect of the disclosure, a method of securing conduit is disclosed which comprises the steps of providing a conduit vise having a channel, and inserting conduit into the channel, the conduit being held against rotation by the conduit vise.

In accordance with yet another aspect of the disclosure, a device for securing conduit against motion is disclosed which comprises a base, a mounting bracket connected to the base and adapted to mount the base to a surface, and a receiver operatively associated with the base, the receiver being adapted to receive the conduit and exert sufficient force on the conduit to hold the conduit against rotation.

These and other aspects and features of the disclosure will become more apparent upon reading the following detailed description when taken in conjunction with the accompanying drawings.

### BRIEF DESCRIPTION OF THE DRAWINGS

FIG. 1 is a perspective view of a vise constructed in accordance with the teachings of the disclosure, with the vise being mounted onto a cart that is constructed in accordance with the teachings of one of my prior patents;

FIG. 2 is an enlarged perspective view of the vise of FIG. 1;

FIG. 3 is an end view of the vise of FIG. 1, with the conduit removed for clarity;

FIG. 4 is a perspective view of a vise constructed in accordance with the teachings of the disclosure having an alternative mounting but provided with a mechanism for mounting the vise onto a cylindrical pail; and

FIG. 5 is a perspective view of a vise similar to those of FIGS. 1-4 having an alternative mounting mechanism for mounting the vise onto a ladder step or the like.

While the following disclosure is susceptible to various modifications and alternative constructions, certain illustrative embodiments thereof have been shown in the drawings and will be described below in detail. It should be understood, however, that there is no intention to limit the disclosure to the specific forms disclosed, but on the contrary the intention is to cover all modifications, alternative constructions, and equivalents.

### DETAILED DESCRIPTION OF THE DISCLOSURE

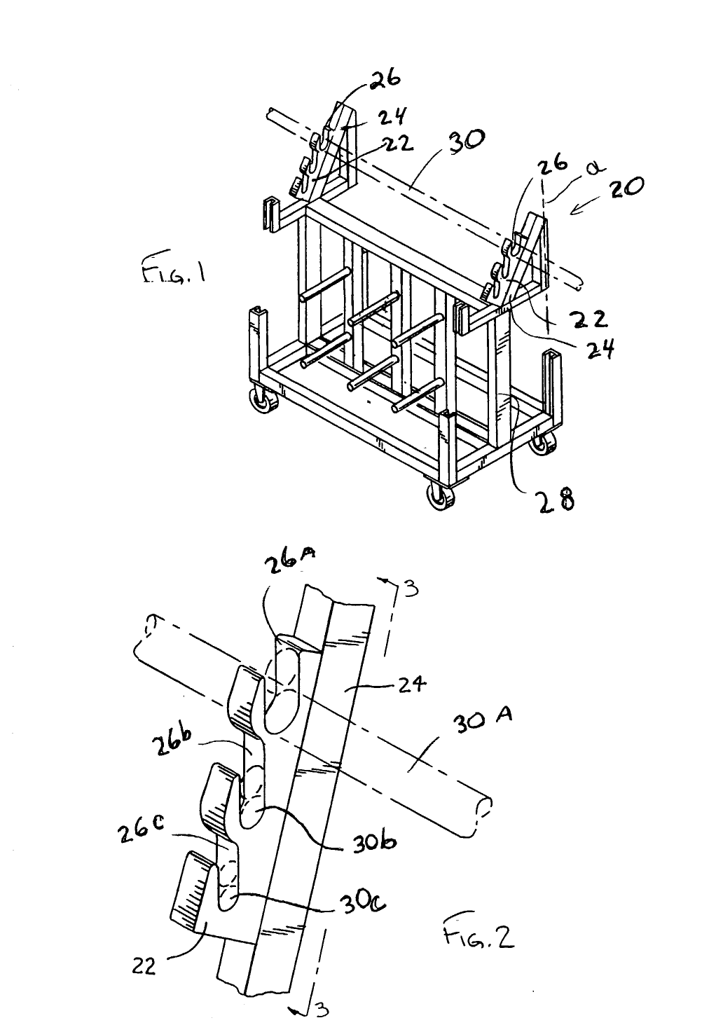

Referring now to the drawings, and with specific reference to FIG. 1, a vise constructed in accordance with the teachings of the disclosure is generally referred to by reference numeral 20. While the vise 20 is depicted as, and will be described in further detail herein with respect to, holding and securing electrical conduit such as EMT, it is to be understood that the teachings of the disclosure can be employed with equal efficacy in holding any comparable cylindrical structures such as, but not limited to, flexible electrical conduit, solid metallic stock such as reinforcing rod, wooden dowels, and the like.

Referring now to FIGS. 1-3, the vise 20 is illustrated to include a base 22, a mounting bracket 24 and, a plurality of receivers 26. Moreover, as depicted in the embodiment of FIG. 1, the vise 20 is mounted on a cart 28 adapted for use by an electrician or the like in transporting and pulling wire, as well as related activities. Examples of such carts are disclosed in my previous U.S. Pat. Nos. 5,509,671 and 5,915,646, the disclosures of which are expressly incorporated herein by reference.

Referring now specifically to FIG. 3, vise 20 is shown to include three receivers 26, each being differently sized. While undepicted, it is to be understood that the teaching of the disclosure can be used to manufacture a vise with only a single receiver, or a number different than that depicted in the figures. However, the embodiment of FIG. 3 depicts three receivers 26, each being differently sized so as to be able to receive conduit 30 of different diameters. For example, the receiver 26a is depicted to receive conduit 30a having an outer diameter of approximately one inch, the receiver 26b is adapted to receive conduit 30b having an outsider diameter of approximately three-quarters of an inch, and the receiver 26c is adapted to receive conduit 30c having an outside diameter of approximately one half inch.

The receivers 26 are able to secure the conduit 30 because the width D (FIG. 3) of each receiver 26 is slightly less than the outer diameter of the conduit 30 to be positioned therein. Accordingly, side walls 36 and 38 of each receiver 26 are adapted to impart sufficient frictional engagement against the conduit 30 so as to hold the conduit 30 against linear and rotational movement.

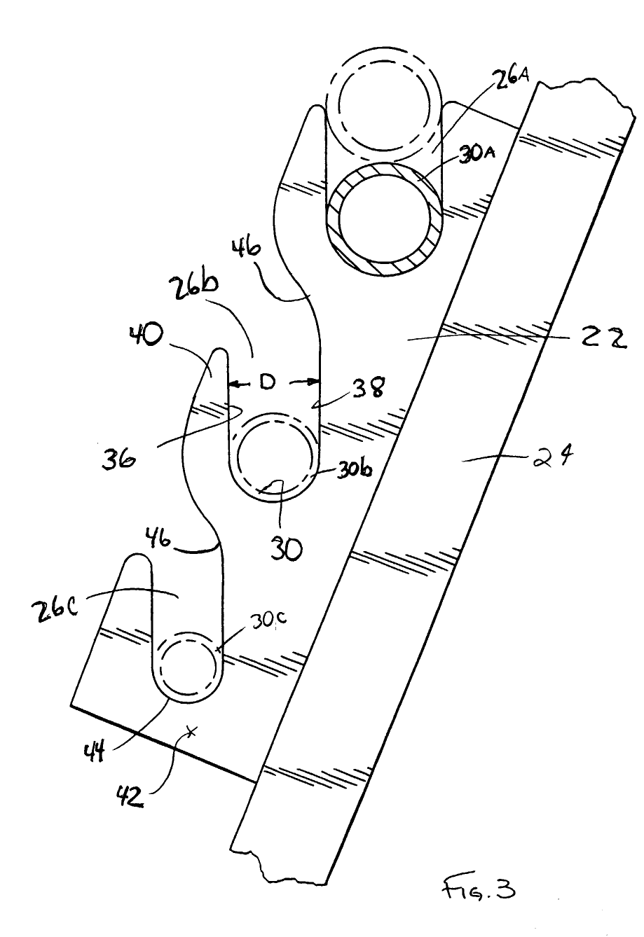

Moreover, each of the receivers 26 is at least partially formed by a deflectable arm 40. Accordingly, when the conduit 30 is inserted into a receiver 26, as depicted in FIGS. 2 and 3, the deflectable arm 40 deflects about a pivot point, generally indicated by reference numeral 42, to a degree sufficient to allow conduit 30 to be received therein. However, since the base 22 of the vise 20 is preferably manufactured from steel or the like, the receivers 26 substantially retain their shape so as to ensure the conduit is adequately held.

It will also be noted that each of the receivers 26 is formed having a semicircular bottom wall 44 so as to tightly grip the conduit 30 about a substantial portion of its circumference. Each of the receivers 26 further includes an arcuate mouth 46 to facilitate easy insertion of the conduit 30 therein.

Referring now to FIG. 1, the base 22 is shown extending from a mounting bracket 24. The base 22 can be so secured to the mounting bracket 24 as by welding, or any other conventional mechanical means such as, but not limited to, nuts, bolts, rivets, and the like. Moreover, the mounting bracket 24 is depicted as being slanted relative to a vertical axis a so as to facilitate access to each of the receivers 26. However, it is to be understood that in alternative embodiments, the mounting bracket 24 could be provided so as to provide a base 22 in a completely vertical orientation, completely horizontal orientation, an arcuate/circular orientation, or any variation thereof.

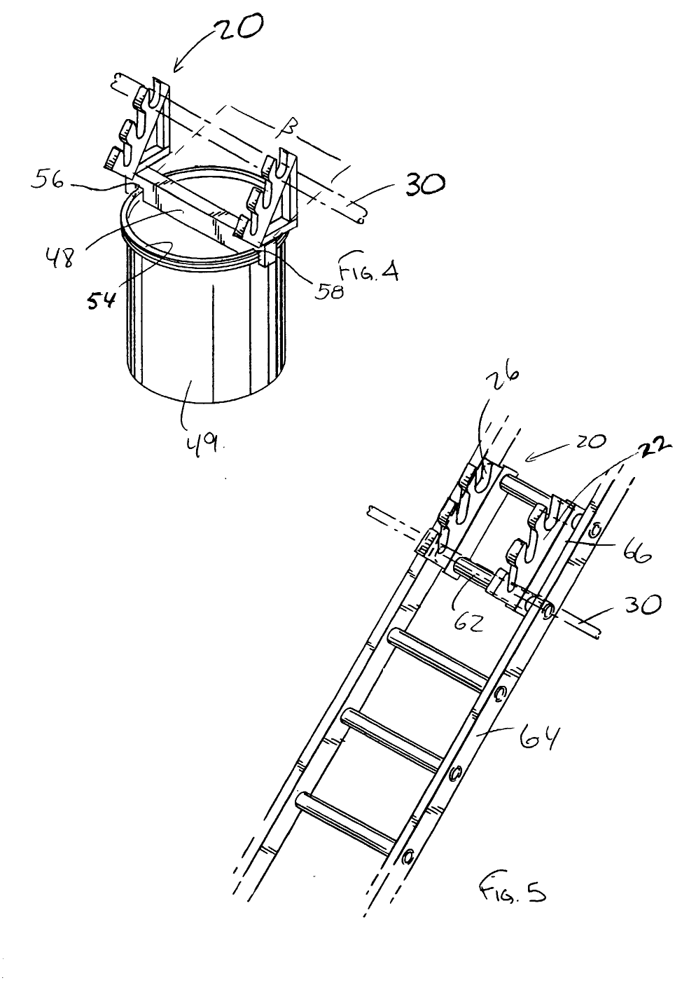

In an alternative embodiment, depicted in FIG. 4, the vise 20 is provided in substantially the same form except for the provision of a strut 48. The strut 48 of FIG. 4 is provided so as to enable the vise 20 to be mounted atop a cylindrical structure such as a traditional five gallon pail 49 or the like. As such pails are commonly strewn about worksites, and used as make shift work surfaces, such a strut 48 facilitates use of the vise 20 in real world environments. Moreover, the tools used for bending, cutting, and machining the EMT and other conduits are typically carried by installers within such commonly available pails. Accordingly, by providing such a strut 48, the user is not only able to cut and machine the conduit as desired, but upon completion of the process, the vise 20, and associated tooling, can be simply thrown into the pail 49 and transported to the next job site.

With regard to specifics of the strut 48, FIG. 4 depicts a width β sufficient to straddle between a pail rim 54. Moreover, the strut 48 includes first and second slots 56, 58 which are themselves sized to receive the width of the rims 54. The slots 56, 58 are advantageously spaced apart a distance corresponding to the diameter of the pail 49 so as to optimize the applicability of the vise 20. In alternative embodiments, a plurality of slots could be provided at varying distances to ensure that, regardless of the size of the cylindrical structure or pail, the mounting bracket 48 would be able to be mounted thereon. The remainder of the vise 20 is substantially the same as the embodiment of the FIG. 4. More specifically, the base 22 extends from the mounting bracket 48 with a plurality of receivers 26 being provided therein. As depicted, the mounting bracket 48 may include first and second vises 20 to secure the conduit 30 in a substantially horizontal and stable manner.

The embodiment of FIG. 5 depicts a further modification of the general idea illustrated above. However, with the embodiment of FIG. 5, the vise 20 is provided with a mounting bracket 66 for securing the vise 20 to a step 62 of a ladder 64. Since such ladders, e.g. extension ladders, straight ladders, and step ladders, are also commonly available on most work sites, such an embodiment can be readily utilized by those of ordinary skill in the art. In fact, such ladders are often currently used as make-shift surfaces for such cutting operations, but still require the user to exert manual force on the conduit to hold the conduit in place against the surface of the ladder step. By providing a mounting bracket 66 which is adapted to be mounted onto such a ladder, the stability of the vise 20 is enhanced.

From the foregoing, one with ordinary skill in the art will readily appreciate that the teaching of the disclosure can be used to construct a conduit vise adapted to securely and accurately hold a conduit, such as electrical metallic tubing, so as to facilitate cutting and shaping operations associated therewith.

What is claimed is:

1. A conduit vise, comprising:
a base; and
a channel formed in the base and adapted to frictionally receive conduit therein, the channel being substantially motionless.

2. The conduit vise of claim 1, wherein the channel is substantially U-shaped.

3. The conduit vise of claim 2, wherein the channel includes a width slightly smaller than a diameter of the conduit.

4. The conduit vise of claim 1, further including a deformable arm extending from the base and partially defining the channel.

5. The conduit vise of claim 1, wherein the base includes a plurality of channels, each channel being adapted to receive a conduit of a different diameter.

6. The conduit vise of claim 1, wherein the base is adapted to be mounted on an angle.

7. The conduit vise of claim 1, further including means for mounting the conduit vise to a cart.

8. The conduit vise of claim 1, further including means for mounting the conduit vise atop a cylindrical pail.

9. The conduit vise of claim 1, further including means for mounting the conduit vise to a ladder.

10. The conduit vise of claim 5, wherein the plurality of channels are sized to receive conduits having diameters of one half inch, three-quarters inch, and one inch.

11. A method of securing conduit to be machined, comprising:
providing a conduit vise having a substantially motionless channel; and
inserting conduit into the channel, the conduit being held against rotation by the conduit vise.

12. The method of claim 11, wherein the conduit is held against rotation by frictional interference.

13. The method of claim 11, wherein the inserting step involves deforming a movable arm relative to a base.

14. The method of claim 11, further including the step of mounting the conduit vise atop a cylindrical pail.

15. The method of claim 14, wherein the mounting step involves mounting first and second conduit vises atop a cylindrical pail.

16. A devise for securing conduit against motion, comprising:
a base;
a mounting bracket connected to the base and adapted to mount the base to a surface; and
a receiver operatively associated with the base, the receiver adapted to receive the conduit and exert sufficient force on the conduit to hold the conduit against rotation, the receiver being substantially motionless.

17. The devise of claim 16, wherein the devise includes no movable parts.

18. The devise of claim 16, wherein the mounting bracket includes first and second slots sized to receive rim edges of a pail.

19. The devise of claim 16, wherein the receiver is adapted to receive conduits of multiple channels.

20. The devise of claim 16, wherein the receiver includes a channel including a width less than the conduit diameter.
